(19) United States
(12) Patent Application Publication
(10) Pub. No.: US 2015/0183493 A1
(43) Pub. Date: Jul. 2, 2015

(54) SHOCK MITIGATION APPARATUS

(71) Applicant: Paul Francis ZWAAN, (US)

(72) Inventor: Paul Francis Zwaan, Christchurch (NZ)

(21) Appl. No.: 14/412,409

(22) PCT Filed: Jul. 4, 2013
(86) PCT No.: PCT/NZ2013/000117

§ 371 Date: Dec. 31, 2014

(30) Foreign Application Priority Data
Jul. 4, 2012 (NZ) 601068

(51) Int. Cl. B63B 29/04; F16F 1/02; F16F 1/22; F16F 3/02; A47C 3/20; A47C 7/02

(52) U.S. Cl. CPC B63B 29/04; A47C 3/20; A47C 7/025; F16F 1/22; F16F 3/02; F16F 1/021; B63B 2029/043

(57) ABSTRACT

Described herein is a shock mitigation apparatus. More specifically, a shock mitigation apparatus which relates to a new and improved seating system, such as may be utilised in a marine environment, able to absorb shocks transmitted to the seat system from a structure to which the seat is affixed. The shock mitigation apparatus includes a tuneable spring to alter and/or control flexure within the spring in three planes of movement (longitudinal surge, vertical heave and lateral sway) and axes of rotation (roll, pitch and yaw) depending on occupant and/or particular application.

### RELATED APPLICATIONS

This application is a 35 U.S.C. §371 National Stage Application of International Application No. PCT/NZ2013/000117, filed Jul. 4, 2013, which derives priority from New Zealand patent application number 601068, filed Jul. 4, 2012, both of which are incorporated herein by reference.

### TECHNICAL FIELD

Described herein is a shock mitigation apparatus. More specifically, a shock mitigation apparatus which relates to a new and improved seating system, such as may be utilised in a marine environment, able to absorb shocks transmitted to the seat system from a structure to which the seat is affixed. The shock mitigation apparatus includes a tuneable spring to alter and/or control flexure within the spring in three planes of movement (longitudinal surge, vertical heave and lateral sway) and axes of rotation (roll, pitch and yaw) depending on occupant and/or particular application.

### BACKGROUND ART

High-speed, high performance watercraft, as used in both military and civilian application, subject the passengers to repetitive high G-forces resulting from the sudden deceleration of the watercraft as it falls off waves or hits waves while going at a high forward speed and a high angle of attack. Such repetitive impacts are both debilitating to the watercraft's occupants, preventing them from carrying out their tasks, and further may result in physical injury.

Shock mitigation is minimising the effects of a shock when watercraft, navigating at high speeds, hits a wave or a series of waves. As above, these effects can cause fatigue and injuries to the boats' passengers and crew especially when subjected to prolonged periods of constant impacts. Whilst a well designed and built boat can mostly withstand these shocks caused by these impacts, the passengers and crew experience an uncomfortable ride which reduces physical, cognitive and psychomotor performance and increases the risk of acute and chronic musculoskeletal injuries.

The effects of prolonged body movements and of the forces acting on the musculoskeletal system due to riding in high speed boats is, at the very minimum, fatigue. At worst, it can result in serious injury or death. Fatigue due to vibration is caused by prolonged muscle activity, both voluntary and involuntary, resulting from the body's attempt to counteract the vibration. The muscle tissue and organs themselves act as shock absorbers that try to dampen vibration and can become fatigued over time. As fatigue continues, the potential for declining work performance and even injury increase due to the unpredictable nature of shocks that come from high speed navigation in significant waves.

U.S. Pat. No. 5,810,125 discloses an active shock-absorbing boat seat system that has a seat system mounted to the boat deck through an active shock absorber. Sensors monitor both the shock to be passed from the deck to the seat as well as the shock actually received by the seat after passing through the shock absorbing system. A controller monitors the shock levels and provides a continuous control signal to the shock-absorbing unit to control the response of the shock-absorbing unit during the duration of the shock. The control system can provide for adjustment of various operating parameters for the system, including initial position of the seating system, overall ride stiffness, maximum allowable shock, and other parameters.

However, a disadvantage of U.S. Pat. No. 5,810,125 is that to mitigate shock, the system requires the use of an array of components such as complex electronic controllers, sensor units, electrohydraulic servo actuators and the like. This increases the costs and potential for failure and may require ongoing maintenance especially in a marine environment.

A purely mechanical assembly for a shock absorbing boat is disclosed in U.S. Pat. No. 6,889,625 where the assembly includes a horizontal base that is hingedly connected to the transom to pivot about a horizontal axis. The base is supported by a spring bias means connected to the hull. Shock absorbers may also be connected to reduce the vibration of the base when the hull is moving at high speeds. However, a disadvantage of U.S. Pat. No. 6,889,625 is that to accommodate the shock absorbing assembly, the entire transom assembly of the boat has to be modified or the shock absorbing assembly needs to be incorporated into the build of the boat during manufacture.

Another mechanical arrangement for a shock absorbing boat seat assembly is disclosed in U.S. Pat. No. 6,386,635. This arrangement is generally known in the industry as a ‘soft rider pedestal seat’ where the means for absorbing shock includes a shaft disposed in a tubular member and a valve body for controlling an amount of pressure of compressed air in the hollow tubular member and further includes a coil spring.

US 2009/0283944 discloses a shock mitigation apparatus which comprises a scissors support for a load, such as a seat and occupant, with respect to a base structure to which the apparatus is mounted. Shock-absorption is provided by the parallel arrangement of a damper and spring. The damper is connected to an accumulator having an adjustability feature to allow the damper to be preloaded for the static load of the seat and occupant. A similar scissor support configuration is disclosed in U.S. Pat. No. 6,098,567, but with a pair of coiled springs in a vertical orientation.

However, a problem with all of the mechanical arrangements described above is that they only allow primary shock mitigation in one direction i.e. vertical movement only. Optimally, mitigation apparatus also should factor in lateral stability requirements of occupants where a lateral impact force can have a considerable effect on the body. A lateral impact force can lead to excessive lateral movement of the torso and neck resulting in spinal injuries.

There are a number of other specialist shock mitigation apparatus known in the art with varying configurations manufactured by companies such as Shockwave seats, Ullman Dynamics, Coastshox, X-Craft Suspension Seats and Scot Seats to name a few. However, as above the majority of the shock mitigation apparatus manufactured by these companies only allow for primary shock mitigation i.e. vertical movement only. Also, they do not give the degree of height adjustability in the vertical axis without compromising the progressive travel of the spring damper system.

To overcome the problem of the above, Scot Seats have developed an exemplary shock mitigation seat system which in addition to primary mitigation allows for secondary mitigation in the lateral direction. However, as a result of the rigid construction of the mounting point pivot members, additional componentry referred to as a “shuffle system” is required to effect mitigation in the lateral direction. This results in additional costs for manufacture and a more complex arrangement of componentry to achieve its objective than is necessary. Furthermore, this mitigation seat system does not allow for ease of tuneability to alter and/or control flexure within the spring in three planes of movement (longitudinal surge, vertical heave and lateral sway) and axes of rotation (roll, pitch and yaw) depending on occupant and/or particular application.

It should be appreciated from the above, that there is a need for a shock mitigation apparatus which is capable of counteracting impact motion in three planes of movement and axes of rotation, substantially preventing the resulting forces which are transmitted to a seat occupant through the seat structure, from reaching the seat and its occupant; yet allows for a degree of adjustability in the vertical axis without compromising the progressive travel of the spring damper system along with tuneability to alter and/or control flexure within the spring in all three planes of movement and axes of rotation depending on the occupant and/or particular application. Furthermore, it would be advantageous if the above can be achieved with a simplified design requiring minimal componentry or to at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

For the purpose of this specification the term ‘comprise’ and grammatical variations thereof shall have an inclusive meaning—i.e. that it will be taken to mean an inclusion of not only the listed components it directly references, but also other non-specified components or elements.

Further aspects and advantages of the process and product will become apparent from the ensuing description that is given by way of example only.

### SUMMARY

Described herein is a shock mitigation apparatus. The shock mitigation apparatus may be utilised in a marine environment, able to absorb shocks transmitted to a seat system from a structure to which the seat is affixed. The shock mitigation apparatus includes a tuneable leaf spring to alter and/or control flexure within the leaf spring in three planes of movement (longitudinal surge, vertical heave and lateral sway) and axes of rotation (roll, pitch and yaw) depending on occupant and/or particular application.

In some embodiments there is provided a shock mitigation apparatus including:

at least one seat member;
at least one base assembly for supporting the seat member;
a lower clamp member configured to securely mount to side support members attached to the base assembly;
an upper clamp member configured to securely mount to side support members attached to the seat member;
at least one leaf spring clamped therebetween the lower and upper clamp members,
wherein the leaf spring includes at least one aperture therein configured to tune and control flexure within the leaf spring for shock mitigation in three planes of movement and axes of rotation.

In some embodiments there is provided a shock mitigation apparatus including:

at least one seat member;
at least one base assembly for supporting the seat member;
a lower clamp member configured to securely mount to side support members attached to the base assembly;
an upper clamp member configured to securely mount to side support members attached to the seat member;
a pair of leaf springs spaced apart in a substantially parallel arrangement with respect to each other and clamped therebetween the lower and upper clamp members,
wherein the leaf springs includes at least one aperture therein configured to tune and control flexure within the leaf springs for shock mitigation in three planes of movement and axes of rotation.

In some embodiments there is provided a shock mitigation apparatus including:

at least one seat member;
at least one base assembly for supporting the seat member;
a lower clamp member configured to securely mount to side support members attached to the base assembly;
an upper clamp member configured to securely mount to side support members attached to the seat member;
at least one leaf spring clamped therebetween the lower and upper clamp members;
at least one damper for minimising oscillation of the leaf spring,
wherein the leaf spring includes at least one aperture therein configured to tune and control flexure within the leaf spring for shock mitigation in three planes of movement and axes of rotation.

In some embodiments there is provided a shock mitigation apparatus including:

at least one seat member;
at least one base assembly for supporting the seat member;
a lower clamp member configured to securely mount to side support members attached to the base assembly;
an upper clamp member configured to securely mount to side support members attached to the seat member;
at least one leaf spring clamped therebetween the lower and upper clamp members,
wherein the leaf spring includes at least one aperture therein configured to tune and control flexure within the leaf spring for shock mitigation in three planes of movement and axes of rotation; and
wherein the lower clamp member is in a substantially central alignment with respect to the seat member such that a force during shock mitigation acts directly under a centre of mass of the seat member to provide stability and minimise moment about the apparatus.

In some embodiments there is provided a shock mitigation apparatus including:

at least one seat member;
at least one base assembly for supporting the seat member;
a lower clamp member configured to securely mount to side support members attached to the base assembly;
an upper clamp member configured to securely mount to side support members attached to the seat member;
at least one leaf spring clamped therebetween the lower and upper clamp members,
wherein the leaf spring includes at least one aperture therein configured to tune and control flexure within the leaf spring for shock mitigation in three planes of movement and axes of rotation; and
wherein the lower or upper clamp members include a height adjustment mechanism configured to tilt one cantilever end of the leaf spring to provide adjustment of the seat member in a vertical plane of movement without affecting vertical travel of the leaf spring and/or a damper inserted therebetween.

The shock mitigation apparatus described above confers a number of advantages. A first advantage may be that the apparatus allows for shock mitigation in three axes i.e. three planes of movement and axes of rotation. This may enable an occupant to reduce the amount of shock transmitted to their body from both vertical and lateral impact forces thereby preventing excessive movement of the torso and neck and less likelihood of spinal injuries (unlike coil or air springs that function in only one direction). Secondly, the apparatus is adjustable where the aperture therein the leaf spring allows the leaf spring to be tuned and control the amount of flexure or compliance required depending on occupant and particular application. This overcomes a problem of prior art shock mitigation apparatus where the flexure of the spring is not tuneable. For example, the flexure may be tuned to provide a progressive rate spring or may be to control the stiffness of the spring independently of the three axes where a softer or firmer spring may be manufactured to accommodate side loadings without altering the spring stiffness vertically and/or fore and aft. Also, for apparatus durability, the aperture minimises bending stress of the spring at a region where the spring is clamped to the clamping members. Another advantage of having an aperture in the spring is that it may have a secondary physical function acting as a clearance hole to allow fitment of optional componentry such as a damper to pass through the spring. The use of a pair of leaf springs in a substantially parallel arrangement provides for additional torsional rigidity of the apparatus. Furthermore, the apparatus may include a height adjustment mechanism that allows the seat member to be moved vertically without affecting the vertical travel of the leaf spring and/or optional damper inserted therebetween. Finally, the apparatus is easily configurable depending on user preference. For example, the seat members may be modular allowing interchangeable units of a pommel design, a leaning post attachment and/or a regular design seat without having to replace the entire seat member.

### BRIEF DESCRIPTION OF THE DRAWINGS

Further aspects of the shock mitigation apparatus and uses will become apparent from the following description that is given by way of example only and with reference to the accompanying drawings in which:

FIG. 1 illustrates a perspective view of an assembled shock mitigation apparatus with dual springs and a captain's chair design;

FIG. 2 illustrates a graph of the strength required for sufficient force and deflection (MPa) (with a constant Factor of Safety) for a spring according to embodiments described herein versus material Modulus (GPa);

FIG. 3 illustrates a graph of impacts to failure of a spring versus material of spring;

FIG. 4 illustrates both a plan view of a Factor of Safety (FOS) stress map of a spring and a corresponding side elevation view of a deflection map for optimisation of aperture shape therein of the spring;

FIG. 5 illustrates a graph of the lateral compliance of a spring versus number of, and shape of aperture therein;

FIG. 6 illustrates the relative fore-aft compliance of a spring versus number of, and shape of aperture therein;

FIG. 7 illustrates a graph of a spring with an oval and round aperture which becomes progressively stiffer as it becomes loaded relative to a linear coil spring;

FIG. 8 illustrates a simplified schematic diagram of an applied vertical downward load on a dual spring assembly mitigation apparatus of FIG. 1 in use;

FIG. 9 illustrates a simplified schematic diagram of an alternative embodiment of a height/pre-tension adjustable shock mitigation apparatus;

FIG. 10 illustrates a cross-sectional view of the same alternative embodiment of FIG. 9;

FIG. 11 illustrates a seat member in the form of a single shell pommel design;

FIG. 12 illustrates a series of interchangeable seat member modules;

FIG. 13 illustrates a pommel seat member design with an optional side bolster;

FIG. 14 illustrates a seat member with a removable back pad insert;

FIG. 15 illustrates a rear view of a series of seat member modules with fasteners for securing a back insert and seat accessories;

FIG. 16 illustrates a seat member orientated in a forward direction with respect to the base assembly (16A), and a seat member mounted in a reverse direction with respect to the base assembly (16B);

FIG. 17 illustrates alternative embodiments of the shock mitigation apparatus where the damper is mounted either through the leaf spring or behind the leaf spring;

FIG. 18 illustrates a top and bottom view of a base assembly of the shock mitigation apparatus in the form of a plinth;

FIG. 19 illustrates a side view of a plurality of shock mitigation apparatus: mounted to a single plinth, a larger footprint plinth and mounted directly to a surface via side member supports;

FIG. 20 illustrates a side view of a shock mitigation apparatus with a base assembly in the form of an extended side member support for direct mounting to a surface; and

FIG. 21 illustrates a plurality of shock mitigation apparatus with seat accessories.

### DETAILED DESCRIPTION

As noted above, described herein is a shock mitigation apparatus. The shock mitigation apparatus may be utilised in a marine environment, able to absorb shocks transmitted to a seat system from a structure to which the seat is affixed. The shock mitigation apparatus includes a tuneable leaf spring to alter and/or control flexure within the leaf spring in three planes of movement (longitudinal surge, vertical heave and lateral sway) and axes of rotation (roll, pitch and yaw) depending on occupant and/or particular application.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

The term ‘leaf spring’ or grammatical variations thereof refers to at least one strip of material distinct from a coil, that stores potential energy when it is compressed, stretched, or bent and releases that energy when a restraining force is removed. A non-limiting example of a leaf spring may take the form of a substantially rectangular cross-section with a semi-elliptical, elliptical, parabolic shape, or S-shape when under load. For ease of reference, the ‘leaf spring’ may be simply referred to as a ‘spring’ throughout the specification.

The term ‘aperture’ or grammatical variations thereof refers to a hole(s) or opening(s) of a leaf spring therein that can be of varied shapes and/or dimensions specifically shaped by cutting or other means. The purpose of the aperture therein of the leaf spring is to tune and control flexure or compliance within the leaf spring for shock mitigation in three planes of movement and axes of rotation. The shape, multiple number, position and/or dimensions of the aperture(s) may be dependent on the desired flexure characteristics of the spring that may be deemed suitable for a particular occupant and/or application.

The term ‘three planes of movement’ refers to motion or movement of a body with respect to a substantially planar surface, namely in a longitudinal direction (surge fore and aft), vertical direction (heave up and down) and lateral direction (sway side to side).

The term ‘three axes of rotation’ refers to circular motion or movement of a body around an axis of rotation, namely roll, pitch and yaw axes.

The terms ‘lower’ and ‘upper’ with reference to the leaf springs and/or clamp members should be understood to refer to the relative position of the leaf springs and/or clamp members with respect to the base assembly. The lower leaf spring and/or clamp member being the one(s) proximal to the base member and the upper leaf spring and/or clamp member being the one(s) distal to the base member.

In some embodiments there is provided a shock mitigation apparatus including:

at least one seat member;
at least one base assembly for supporting the seat member;
a lower clamp member configured to securely mount to side support members attached to the base assembly;
an upper clamp member configured to securely mount to side support members attached to the seat member;
at least one leaf spring clamped therebetween the lower and upper clamp members,
wherein the leaf spring includes at least one aperture therein configured to tune and control flexure within the leaf spring for shock mitigation in three planes of movement and axes of rotation.

The shape, multiple number, position, and/or dimensions of the aperture(s) therein the leaf spring, may be dependent on the desired flexure characteristics of the leaf spring and tuned for a particular occupant and/or application. The use Factor of Safety (FOS) stress maps may be measured using strain gauges or predicted using computer modelling such as Finite Element Analysis (FEA) software to optimise the above physical aspects of the aperture(s) to give the desired flexure or compliance characteristics.

The applicant has found that the more elongated and tapered the aperture e.g. an elliptical or oval aperture, the more the stress can be evened out within the spring. For example, the band of low stress approximately half way along the spring (where curvature inverts) and the band of highest stress (where the spring is clamped) may be reduced (and hence factor of safety increased) relative to a spring with a circular aperture therein or a spring without an aperture. Preferably, the factor of safety for the stress in a material of the spring is at least greater than or equal 1.

The aperture may be substantially centrally located in the spring therein or may include two or more apertures therein separated by a bridge.

In preferred embodiments, the aperture of the leaf spring may be dimensioned and shaped to minimise bending stress of the leaf spring at a region where the spring may be clamped to the clamping members.

The aperture of the leaf spring may be dimensioned and shaped to tune and control stiffness of the leaf spring independently of the three planes of movement and axis of rotation.

In particular, the applicant has found that flexure or compliance of the spring may be tuned by altering the shape and dimensions of the aperture. For example, the more rounded corners and lateral bridging that may be introduced to the apertures therein of the spring, increases the lateral stiffness. The amount of lateral stiffness desired may vary according to seat type and application. A spring with no aperture may provide maximum lateral stiffness, however this may be at the expense of tuneability of other flexural or compliance characteristics of the spring.

The lateral stiffness or compliance of the spring may approximately range from 0.7 to 1.2 mm/kg laterally and independently of vertical compliance.

Similarly, the fore and aft flexure or compliance of the spring may be tuned where the aperture may be shaped to have an oval direction approximately at right angles to the axis of motion, such that the spring with the oval aperture (which may be of a thicker dimension for the same vertical stiffness) has increased compliance relative to a spring with no aperture. An advantage of the aperture, is that there is a means by which independent control of compliance may be achieved in each of the directions: longitudinal (surge fore and aft), vertical (heave up and down) and lateral (sway side to side).

The aperture of the leaf spring may be dimensioned and shaped to provide a progressive stiffening rate of the flexure within the leaf spring. An advantage of a leaf spring with an aperture clamped to the clamping members as described may be that the spring becomes progressively stiffer as it becomes loaded. This means that the spring may be soft initially, but not bottom out under high loads (400 kg or more).

In preferred embodiments, the flexure of the leaf spring is tuned to provide more flex approximately at a middle region of the leaf spring for an initial soft spring rate response followed by a progressively firmer spring rate response upon further compression of the leaf spring, thereby avoiding bottoming out of the leaf spring against a stop. This provides comfort to an occupant in light conditions and prevents injury from the jarring of hitting a stop under heavy conditions.

The leaf spring may be configured to allow vertical travel of at least 150 mm to avoid bottoming out of the leaf spring against a stop.

The aperture of the leaf spring may be dimensioned and shaped to allow fitment of a damper to pass through the leaf spring. An advantage of a spring with an aperture(s) is that it may allow an optional damper to pass directly through it, rather than in front, behind or to either side of the spring. This means that the damper may be substantially under the centre of mass of the seat and occupant and absorb forces while minimising moments. Also, this configuration may allow for lighter construction of the apparatus without racking or twisting.

A spring with two apertures therein may be asymmetric to allow variation in placement of larger dimensioned apertures where the apertures in upper and lower springs may align or where the larger dimensioned apertures may be at opposite ends with respect to each other to allow for a different trajectory for a damper.

The optional damper may absorb energy and minimise oscillation of the leaf spring and may include a coil spring.

The shock mitigation apparatus may include a pair of lower and upper leaf springs in a substantially parallel arrangement with respect to each other for torsional rigidity.

In an alternative embodiment, there may be one leaf spring with a stabiliser arm pivotally connected to the lower and upper clamp members. In this way, in lieu of an additional leaf spring, vertical movement may occur with a constant inclination where the leaf spring forms an S-shape curve to prevent a pitching motion.

Structural materials commonly used in marine applications may include certain grades of titanium, stainless steel, aluminium, fibreglass and other composites, which may have superior corrosion. However, different materials may need to be isolated from each other to prevent galvanic attack. This may be particularly pertinent to aluminium and carbon parts.

The leaf spring may be manufactured out of the following materials selected from titanium, stainless steel or a composite material. Other factors to consider when selecting a material for a leaf spring of the invention include ultraviolet stability, strength (compressive tensile and shear), flexural modulus/Young's Modulus and Factor of Safety (FOS) derived from strength and modulus data.

More preferably, the leaf spring may be manufactured out of titanium alloy of grade Beta C which has a modulus of approximately 80-120 MPa without any reduction in strength.

The applicant has found that the overall dimensions of width, length and thickness of the leaf spring may be important factors for optimum operation of the shock mitigation apparatus.

The width of the leaf spring may be approximately 100 to 400 mm. More preferably, the width may be 200 mm. If the spring is too narrow, the spring may twist resulting in lack of lateral stability and if the spring is too wide, the spring may not fit under a conventional seat and the occupant or other passenger may contact and collide with the spring when in use. It should be noted that if the spring is doubled in number (e.g. the use of two springs versus one spring irrespective of whether they are configured side by side or one above the other), this may have the same vertical stiffness and therefore the same effect of doubling the width of the spring. Also, the stiffness of the spring may be proportional to the width of the spring i.e. twice as wide results in the spring being twice as stiff (the force required to deflect the spring a given distance is doubled).

The length of the spring may be approximately 100 to 500 mm. More preferably, the length may be 400 mm. If the spring is too short, the spring may have limited travel and if the spring is too long, the spring may not fit under a conventional seat and the occupant or other passenger may contact and collide with the spring when in use.

The applicant has found that the length of the spring may need to be at least double the vertical stroke, wherein a typical vertical stroke of the spring may be approximately 50 to 200 mm. Outside these ranges, either the cushioning effect of the spring may be reduced or the occupant may lose visibility of the horizon at the bottom of travel. It should be noted that if a spring is doubled in number and connected end to end, this may have the same vertical stiffness as doubling the length of the spring. Also, the stiffness of the spring may be inversely proportional to the cube of its length i.e. twice as long results in the spring being eight times less stiff (the force required to deflect the spring a given distance is reduced by a factor of eight).

The thickness of the spring may be approximately 2 to 12 mm depending on the elasticity of the material. Preferably, the thickness of a titanium spring may be 3 mm. Accordingly, increasing the thickness of a leaf spring may make it much stiffer and also may increase the strain when it curves during deflection. For example, in composite materials this strain may cause cracking and may place an upper limit on practical thickness of a material. Conversely, decreasing the thickness of a leaf spring may make it less stiff because the cross-section is reduced. In order to maintain the same stiffness of the spring, a stiffer material may be utilised and have a proportionately higher strength to withstand the more concentrated stresses in the reduced cross-sectional area (since stress is force divided by area). It should be noted that if a spring is doubled in number and configured to be one above the other, this may not have the same vertical stiffness as doubling the thickness of the spring, even if the distance between them is negligible. Also, the stiffness of the spring may be proportional to the cube of the material thickness i.e. a material twice as thick results in the spring being eight times stiffer (the force required to deflect the spring a given distance is increased by a factor of eight). However, the stiffness of two springs sandwiched together may be only double that of the single spring. Without being bound by theory, two springs configured in this way may not deform like a single spring, but may have the ability to slide one over the other during flexure.

The lower and upper clamp members may be symmetrical to provide uniform clamping pressure where the spring(s) may be clamped at each end of the clamp members. The lower clamp member may maintain the end of the spring(s) proximal to the base assembly at a fixed angle relative to the side members and the upper clamp member may maintain the end of the spring(s) distal to the base assembly at a fixed angle relative to the side members.

The seat member may be a modular unit comprising interchangeable units of a pommel design seat, a leaning post attachment and/or a regular chair design seat. In this way, seat modules may be quickly interchanged with or without tools depending on use. For example, a larger size seat to fully sit on for more relaxed use, a leaning post attachment for medium speeds with the ability to change seating preferences according to the sea conditions and the intended speed of travel.

The pommel design seat may extend forward from a back rest to allow an occupant to sit astride and give maximum lateral stability and a firm footing in use.

The seat member may be mounted in a reverse orientation relative to the base assembly to decrease the overall footprint of the apparatus. In this way, a reverse orientation can allow better utilisation of space in some watercraft, altered dynamics and a different aesthetic appeal depending on user preferences.

The seat member may include a swiveling mechanism to enable the seat member to rotate up to 360 degrees with respect to the base assembly. For example, a swivel disc may be included to facilitate turning and locking of the seat for different types of use.

The base assembly may be a plinth. An advantage of a plinth design is that it may include an access port to access a storage compartment contained therein. Also, the plinth may include a floor to provide hidden fastenings and a recess for adjustable positioning and/or fitment of a damper. However, this should not be seen as limiting as a base assembly should be understood to refer to any member about which the apparatus may be secured to a deck or ground surface.

In one embodiment, the base assembly may be flanges integrated or attached to the side member supports to allow direct attachment to a deck or ground surface.

In another embodiment, a plurality of shock mitigation apparatus may be mounted to the base assembly substantially in a row or adjacent to each other. In this way, multiple shock apparatus may be installed in a watercraft to allow multiple users to sit substantially adjacent to or in front/back of each other.

In some embodiments there is provided a shock mitigation apparatus including:

at least one seat member;
at least one base assembly for supporting the seat member;
a lower clamp member configured to securely mount to side support members attached to the base assembly;
an upper clamp member configured to securely mount to side support members attached to the seat member;
a pair of leaf springs spaced apart in a substantially parallel arrangement, one above the other with respect to each other and clamped therebetween the lower and upper clamp members,
wherein the leaf springs includes at least one aperture therein configured to tune and control flexure within the leaf springs for shock mitigation in three planes of movement and axes of rotation.

The use of a pair of leaf springs configured in this way may provide for additional torsional rigidity. This configuration should not be seen as limiting as for example, in an alternative embodiment there may be one leaf spring with a stabiliser arm pivotally connected to the lower and upper clamp members. In this way, in lieu of an additional leaf spring, vertical movement may occur with a constant inclination where the leaf spring forms an S-shape curve to prevent a pitching motion.

In some embodiments there is provided a shock mitigation apparatus including:

at least one seat member;
at least one base assembly for supporting the seat member;
a lower clamp member configured to securely mount to side support members attached to the base assembly;
an upper clamp member configured to securely mount to side support members attached to the seat member;
at least one leaf spring clamped therebetween the lower and upper clamp members;
at least one damper for minimising oscillation of the leaf spring,
wherein the leaf spring includes at least one aperture therein configured to tune and control flexure within the leaf spring for shock mitigation in three planes of movement and axes of rotation.

The use of a damper as described above, may absorb additional energy and minimise oscillation of the leaf spring. The damper may be a hydraulic piston filled with oil or other liquid and optionally may include a coil spring.

In some embodiments there is provided a shock mitigation apparatus including:

at least one seat member;
at least one base assembly for supporting the seat member;
a lower clamp member configured to securely mount to side support members attached to the base assembly;
an upper clamp member configured to securely mount to side support members attached to the seat member;
at least one leaf spring clamped therebetween the lower and upper clamp members,
wherein the leaf spring includes at least one aperture therein configured to tune and control flexure within the leaf spring for shock mitigation in three planes of movement and axes of rotation and;
wherein the lower clamp member is in a substantially central alignment with respect to the seat member such that a force during shock mitigation acts directly under a centre of mass of the seat member to provide stability and minimise moment about the apparatus.

An advantage of the above configuration where the lower clamp member is in substantially central alignment with respect to the seat member is that this may allow for lighter construction of the seat member components without racking or twisting as a force may act substantially under the centre of mass of the components during shock absorption and may reduce excessive swaying of the seat member about the base assembly.

In some embodiments there is provided a shock mitigation apparatus including:

at least one seat member;
at least one base assembly for supporting the seat member;
a lower clamp member configured to securely mount to side support members attached to the base assembly;
an upper clamp member configured to securely mount to side support members attached to the seat member;
at least one leaf spring clamped therebetween the lower and upper clamp members,
wherein the leaf spring includes at least one aperture therein configured to tune and control flexure within the leaf spring for shock mitigation in three planes of movement and axes of rotation; and
wherein the lower or upper clamp members include a height adjustment mechanism configured to tilt one cantilever end of the leaf spring to provide adjustment of the seat member in a vertical plane of movement without affecting vertical travel of the leaf spring and/or a damper inserted therebetween.

In the above embodiment, each of the lower or upper clamp members may be divided into two separate parts comprising a first and second arm, wherein the arms may pivot and slide relative to one another to form a parallelogram arrangement such that an angle of the end of springs may have its inclination angle relative to the seat member adjusted thereby allowing the height adjustment of the seat member.

Advantages of the above shock mitigation apparatus may include the following:
The apparatus may allow for shock mitigation in three axes i.e. three planes of movement and axes of rotation. This may enable an occupant to reduce the amount of shock transmitted to their body from both vertical and lateral impact forces thereby preventing excessive movement of the torso and neck and less likelihood of spinal injuries (unlike coil or air springs that function in only one direction).
The apparatus may be adjustable where the aperture therein the leaf spring allows the leaf spring to be tuned and control the amount of flexure or compliance required depending on occupant and particular application. This overcomes a problem of prior art shock mitigation apparatus where the flexure of the spring is not tuneable. For example, the flexure may be tuned to provide a progressive rate spring or may be to control the stiffness of the spring independently of the three axes where a softer or firmer spring may be manufactured to accommodate side loadings without altering the spring stiffness vertically and/or fore and aft.
The apparatus is durable where the material of the spring and the aperture minimises bending stress of the spring at a region where the spring is clamped to the clamping mechanism.
Another advantage of having an aperture in the spring is that it may have a secondary physical function acting as a clearance hole to allow fitment of optional componentry such as a damper to pass directly through the spring rather than in front, behind or to either side of the spring. This means that the damper unit can be mounted directly under the centre of mass of the seat member and occupant and absorb forces while minimising moments. Also, this configuration may allow for lighter construction of the apparatus without racking or twisting.
The use of a pair of leaf springs in a substantially parallel arrangement provides for additional torsional rigidity of the apparatus.
Furthermore, the apparatus may include a height adjustment mechanism that allows the seat member to be moved vertically without affecting the vertical travel of the leaf spring or optional damper inserted therebetween.
The apparatus is easily configurable depending on user preference. For example, the seat members may be modular allowing interchangeable units of a pommel design, a leaning post attachment and/or a regular design seat without having to replace the entire seat member.

The embodiments described above may also be said broadly to consist in the parts, elements and features referred to or indicated in the specification of the application, individually or collectively, and any or all combinations of any two or more said parts, elements or features, and where specific integers are mentioned herein which have known equivalents in the art to which the embodiments relates, such known equivalents are deemed to be incorporated herein as of individually set forth,

Where specific integers are mentioned herein which have known equivalents in the art to which this invention relates, such known equivalents are deemed to be incorporated herein as if individually set forth.

### WORKING EXAMPLES

The above described shock mitigation apparatus and uses are now described by reference to specific embodiments and examples.

### Example 1

### Non Height Adjustable Dual Leaf Spring

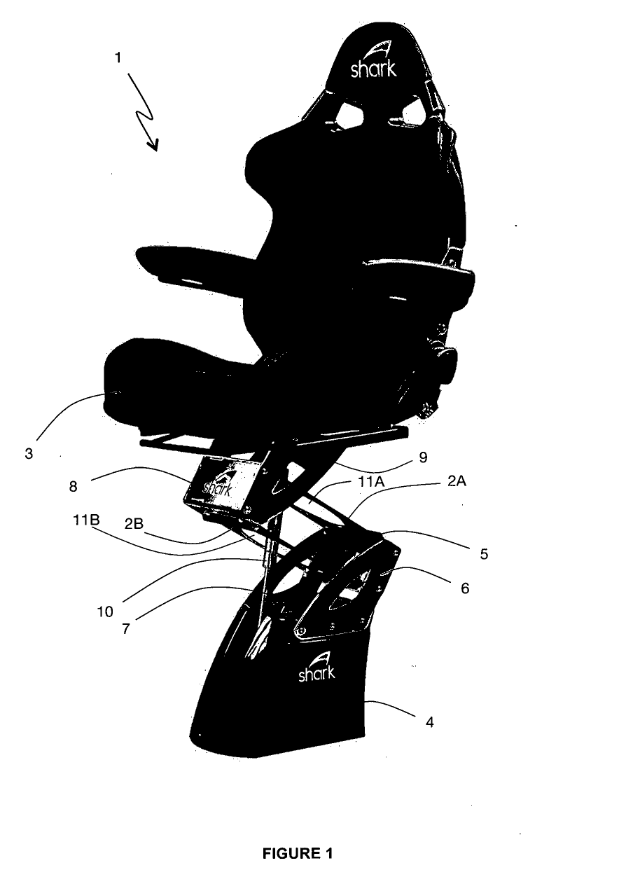

Referring to FIG. 1, an assembled shock mitigation apparatus 1 with dual leaf springs 2A,B and a seat member 3 in the form of captain's chair design is illustrated. A base assembly in the form of a plinth 4 is used to support the seat member 3 and is attached to the sole of a boat (not shown) with fasteners and reinforcing plates/washers (not shown) in known fashion. A lower clamp member 5 is securely mounted to a pair of side support members 6 attached to the base assembly 4. An access port 7 is secured to the top of the plinth 4. A top and bottom leaf spring 2A,B slidingly engages with the lower clamp member 5. In the same way, an upper clamp member 8 is securely mounted to a pair of side support members 9, attached to a bottom assembly of the seat member 3. The lower and upper clamp members 5,8 are linked together via the top and bottom leaf springs 2A,B which are slidingly engaged and secured to the upper and lower clamp members 5,8 with fasteners in known fashion, thereby clamping the leaf springs 2A,B therebetween. The upper clamp member 8 includes a bracket (not shown) for mounting a pair of damper brackets (not shown). A damper 10 is attached to the damper brackets and one end secured to the underside of the upper clamp member bracket. The other end of the damper bracket is configured to mount to a fitting contained within a recess of the plinth 4.

As previously described, the overall dimensions and material of the springs 2A,B is important to the functionality of the mitigation apparatus 1. The springs 2A,B are dimensioned to have a length of 400 mm, width of 200 mm, and thickness of 3 mm when manufactured out of titanium alloy grade “Beta C”.

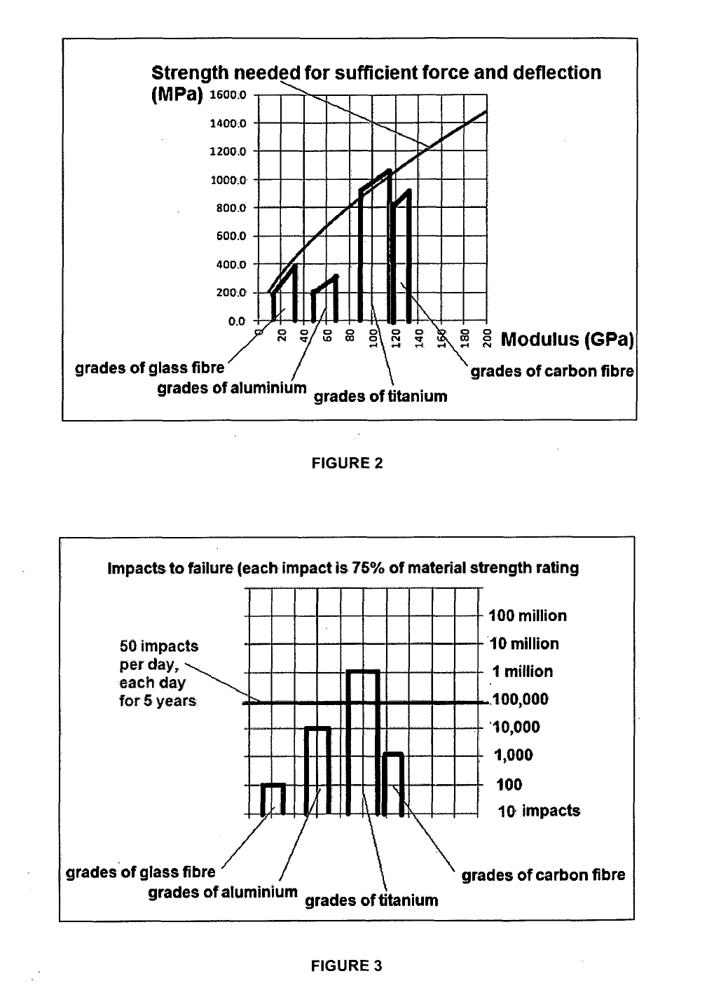

FIG. 2 shows a graph of the necessary strength for sufficient force and deflection (MPa) (with a constant Factor of Safety) required for a spring of the invention versus material Modulus (GPa). From the graph of FIG. 2, it is possible to compare materials by calculating the required strength for springs of each material (glass fibre, aluminium, titanium and carbon fibre) which have identical length, width and stiffness. When actual material strengths are plotted on this graph, most materials fall below the requirement (the strength required as a result of the ratio of their strength to stiffness being too low). Of the corrosion-resistant materials analysed, only titanium exceeds the requirement and only high-performance composites come close to matching the performance of titanium.

Another factor in determining the optimum spring material is fatigue life as shown in FIG. 3. For composites (fibreglass, carbon fibre, kevlar), the life span is significantly reduced due to early crack formation and propagation. The applicant has found that attempts to mitigate this by layering with fibres in weaves of differing orientation do not produce significant fatigue life improvement over 1000 cycles. Only by operating at stresses below half the rated strength of the composite can reasonable life be achieved. However, the stiffness and maximum displacement of the spring is compromised.

For the above reasons, titanium alloy is the preferred material for use with this invention, in particular grade “Beta C” which has the 20% lower modulus without any reduction in strength.

Referring back to FIG. 1, the leaf springs 2A,B include an aperture 11A,B configured to tune and control flexure within the springs 2A,B for shock mitigation in three planes of movement and axes of rotation.

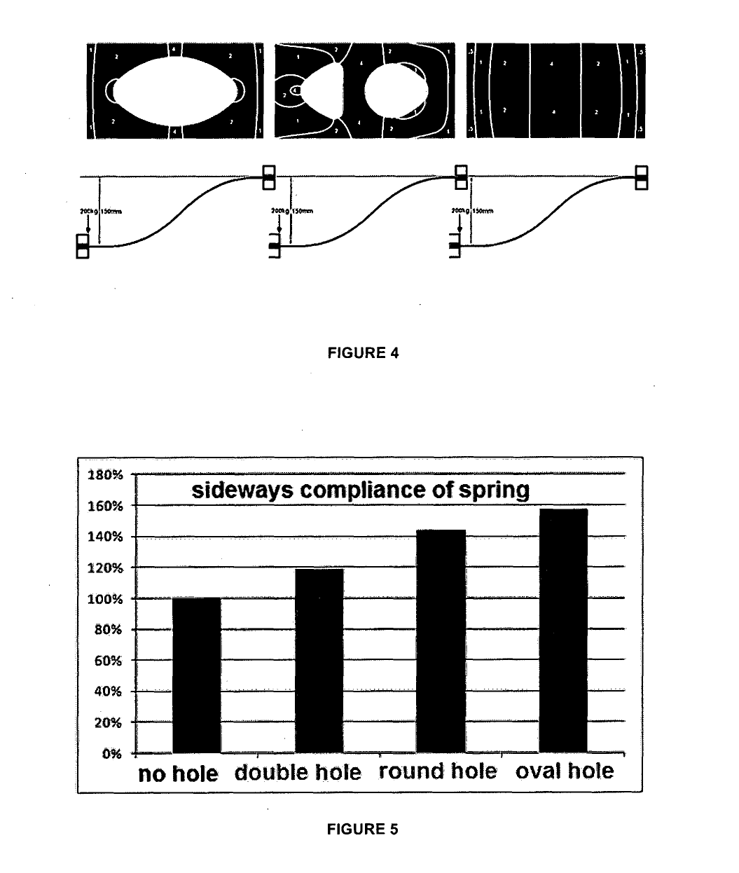

FIG. 4 shows a diagram of improved Factor of Safety (FOS) by optimisation of aperture shape therein of the spring. In particular, the diagram shows Factor of Safety (FOS) stress maps for springs of identical stiffness, length and width, but with different thickness, number and shape of apertures under identical loading conditions (200 kg force per spring and 150 mm deflection). These maps are measured using stress gauges and/or predicted using Finite Element Analysis software (FEA) where factors above 1 indicate the material is operating within specification and factors below 1 indicate the material is being overloaded. From the maps, it can be seen that the more elongated and tapered the aperture becomes, the more the stress is uniformly distributed about the spring. For example, the band of low stress half way along the spring (where curvature inverts) is reduced and the band of highest stress (with a FOS of only 0.5 in the spring with no aperture) is eliminated. The double aperture is intermediate between these two extremes.

Also, the torsional flexure or compliance of the spring is tuned/controlled by altering the aperture 11 size and shape. The more rounded corners and lateral bridging that are introduced to the apertures 11 of the spring 2A,B increases the lateral stiffness. The amount of lateral stiffness desired is varied according to seat type and application. A spring with no aperture provides maximum lateral stiffness (possibly too stiff for desired application), and at the expense of tuneability of other flexural or compliance characteristics of the spring. FIG. 5 shows a graph of the sideways (lateral) compliance of the spring shapes as described previously above. Again, these are springs with identical stiffness/compliance in the vertical (heave) axis.

The lateral compliance is varied from 0.7 to 1.2 mm/kg and independently of the vertical compliance of the spring.

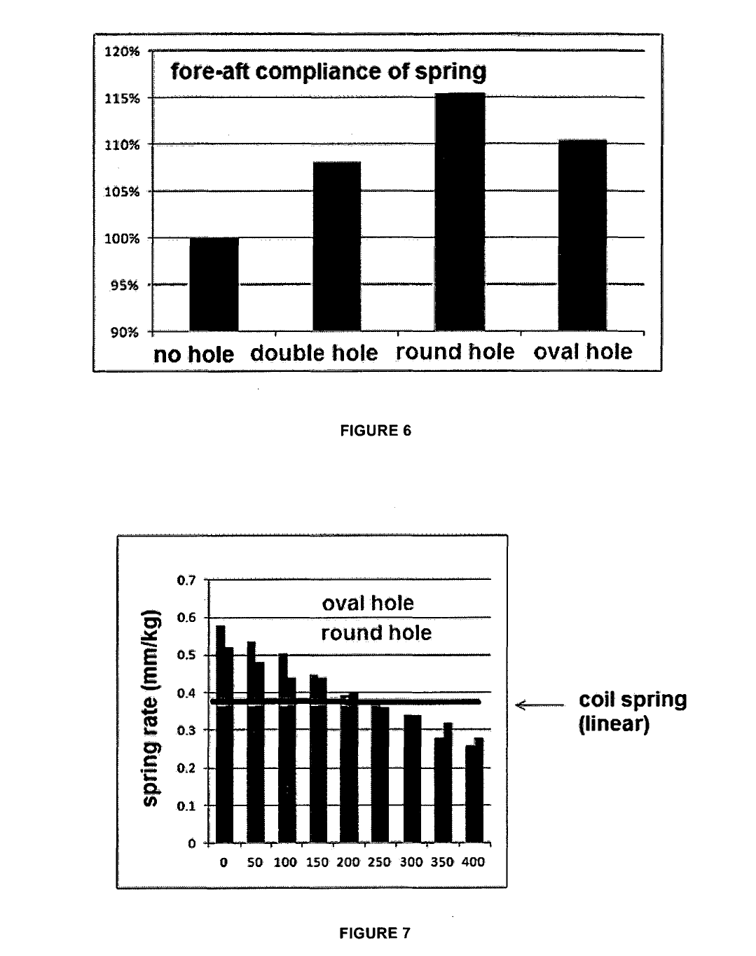

Similarly, the fore and aft flexure or compliance of the spring 2A,B is tuned as shown in FIG. 6 where the aperture is shaped to have an oval direction approximately at right angles to the axis of motion, such that the spring 2A,B with the oval aperture (which is of a thicker dimension for the same vertical stiffness) has increased compliance relative to a spring 2A,B without a round aperture and where both have the same compliance in the vertical (heave) direction. The aperture, allows for independent control of compliance may be achieved in each of the directions: longitudinal (surge fore and aft), vertical (heave up and down) and lateral (sway side to side).

Also, the aperture of the leaf spring 2A,B is dimensioned and shaped to provide a progressive stiffening rate of the flexure within the leaf spring 2A,B. In particular, FIG. 7 shows a spring with an oval and round aperture which becomes progressively stiffer as it becomes loaded relative to a linear coil spring. This means that the spring may be soft initially, but not bottom out under high loads (400 kg or more).

The flexure of the leaf spring 2A,B is tuned to provide more flex approximately at a middle region of the leaf spring for an initial soft spring rate response followed by a progressively firmer spring rate response upon further compression of the leaf spring 2A,B, thereby avoiding bottoming out of the leaf spring 2A,B against a stop. This provides comfort to an occupant in light conditions and prevents injury from the jarring of hitting a stop under heavy conditions.

The leaf spring 2A,B is configured to allow vertical travel of at least 150 mm to avoid bottoming out of the leaf spring 2A,B against a stop (not shown).

### Example 2

### Non Height Adjustable Dual Leaf Spring in Use

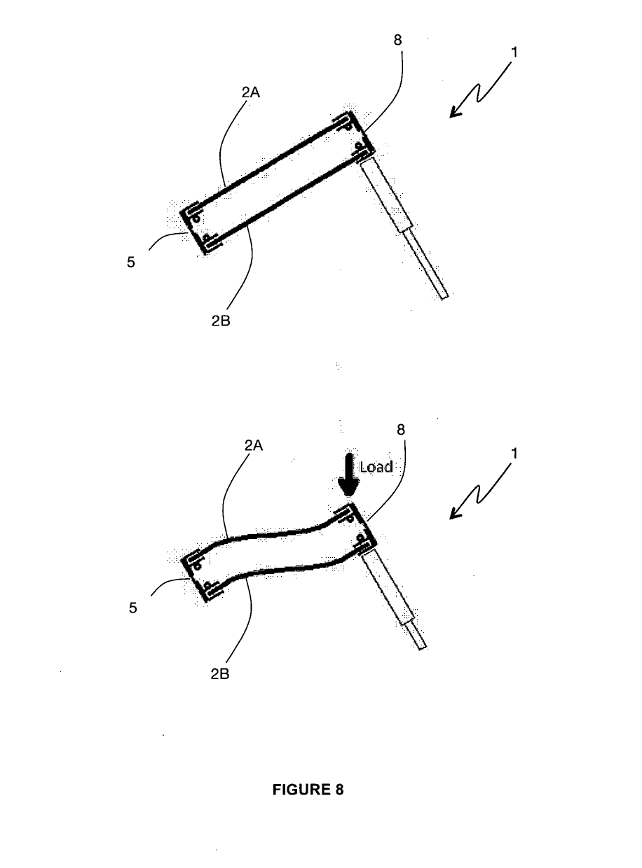

Referring to FIG. 8, a simplified schematic diagram shows an applied load on a dual spring assembly mitigation apparatus 1 of FIG. 1 in use. The seat member, side mounting plates and plinth are not shown for clarity. The springs 2A,B are clamped at each end of the clamping members 5,8 where the lower clamp member 5 maintains one end of the springs 2A,B at a fixed angle relative to the side support members (not shown) and plinth (not shown). The upper clamp member 8 also maintains the distal end of the springs 2A,B at a fixed angle relative to the side support members and seat assembly. As can be seen, once a vertical load force is applied downwards to the shock mitigation apparatus 1, a deflection in the springs 2A,B in the form of an S-shaped curve is imparted thereby absorbing the vertical load force.

### Example 3

### Height Adjustable Dual Leaf Spring

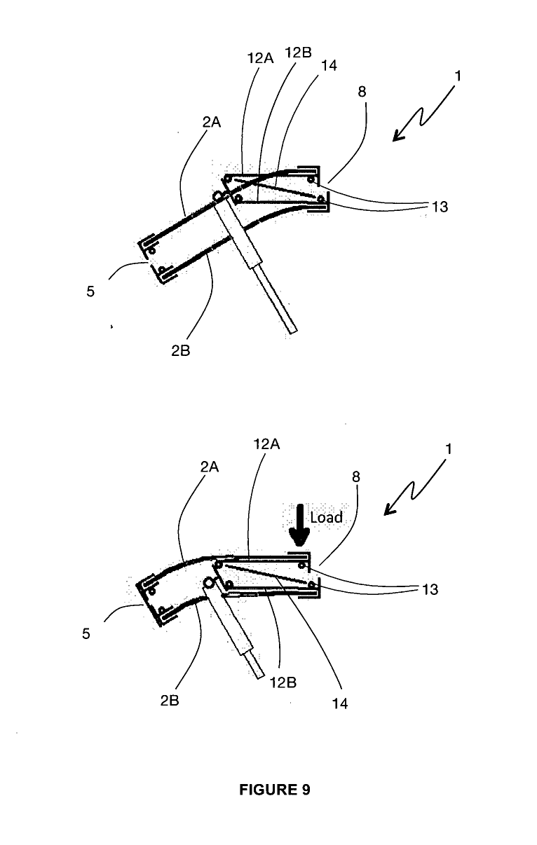

With reference to FIG. 9, a simplified schematic diagram shows a height/pre-tension dual spring adjustable shock mitigation apparatus embodiment 1 wherein the upper clamp member 8 includes a height adjustment mechanism configured to tilt one cantilever end of the leaf spring 2A,B to provide adjustment of the seat member (not shown) in a vertical plane of movement without affecting vertical travel of the leaf springs 2A,B or a damper 10 inserted therebetween.

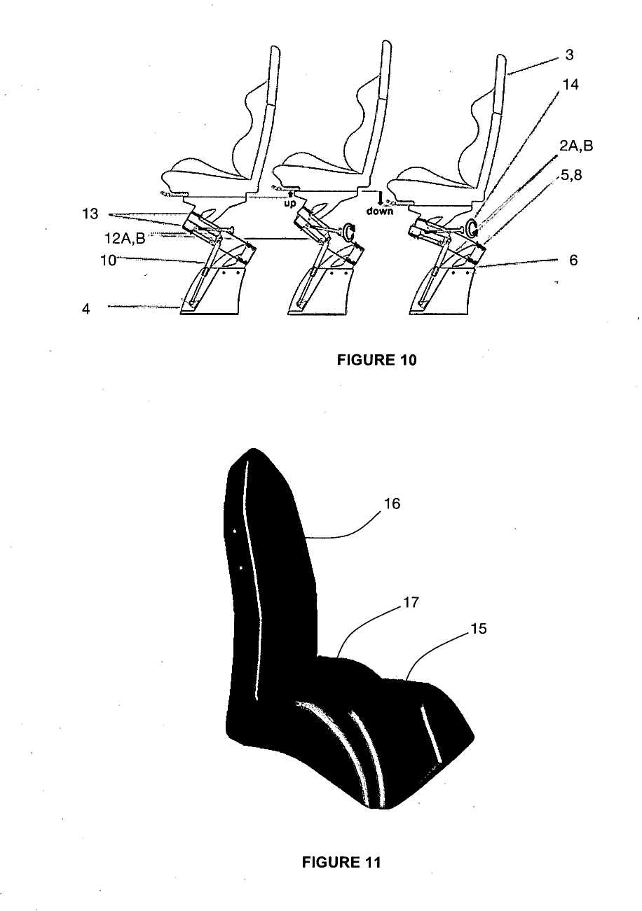

In this embodiment (best seen in FIG. 10), the upper clamp members 5,8 are divided into two separate parts comprising a first and second arm 12A,B, wherein the arms 12A,B pivot and slide relative to one another to form a parallelogram arrangement such that an angle of the end of springs 2A,B have its inclination angle relative to the seat member 3 adjusted thereby allowing the height adjustment of the seat member 3.

In particular, each individual upper clamp member 5,8 is rigidly attached to an arm 12A,B with a pivot 13 at each end. The pivot 13 proximal to the clamp member allows that clamp member to pivot about an axis which is proximal to the distal end of the spring 2A,B. The pivot at the other end (proximal to the damper) is attached to short link which connects the two arms 12A,B together forming a parallelogram. Adjustment of the inclination of the parallelogram is achieved by a screw thread 14 across the diagonal which pulls or pushes the diagonally opposite pivots (corners of the parallelogram) closer or further apart. As the screw thread 14 is rotated in an anti-clockwise direction the height adjustment mechanism operates as follows:
1. the pivots move apart and the angle of the springs are made to tilt less (i.e. become more horizontal) which has the effect of lowering the seat member which is mounted to the upper clamp member via the side support members;
2. the springs curve because the pivots are offset slightly from the centreline of the springs (tend to push or pull on the springs) where the upper pivot is pulling and adding tension to the upper spring while the lower pivot is pushing and adding compression to the lower spring;
3. the above has the effect of amplifying the weight of an occupant, making the lowered spring easier to compress. Conversely, the opposite effect occurs during raising of the seat (rotating the screw thread in a clockwise direction), making the springs seem stiffer in the raised setting position; and
4. as the short link is also pivotally connected to the top of the damper (by a third pivot on that link at its midpoint) and this short plate does not move up or down, this maintains a constant available stroke for the damper at all height settings.

### Example 4

### Seat Member Modules

An advantage of the apparatus is that the modular nature of the design allows for a number of variations to the seat member modules. The following seat modules are shown in the following Figures:

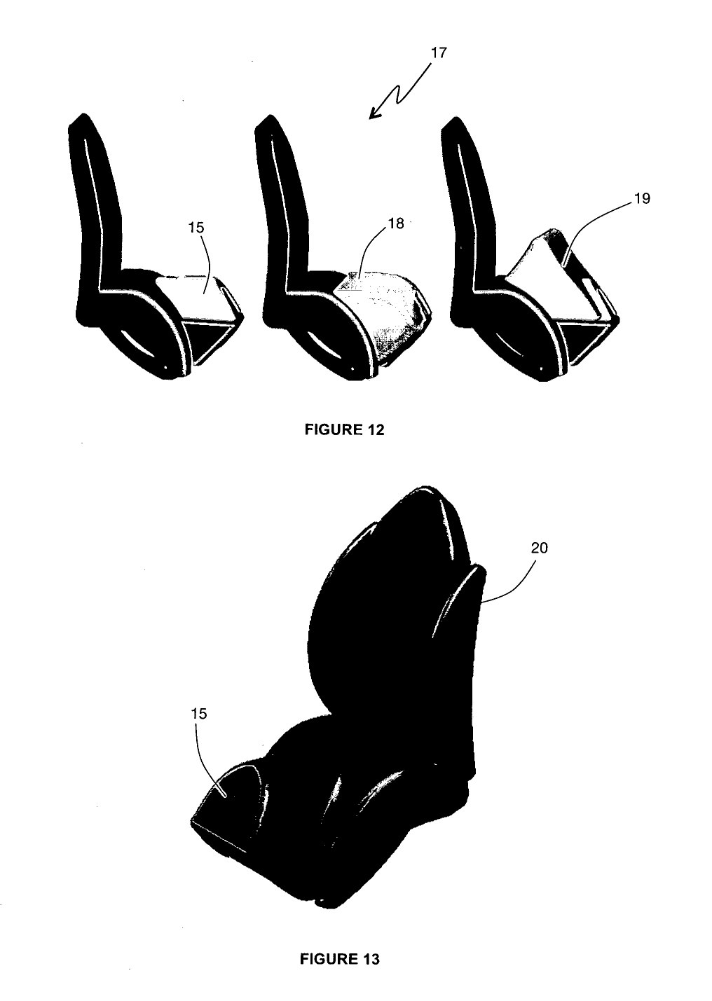

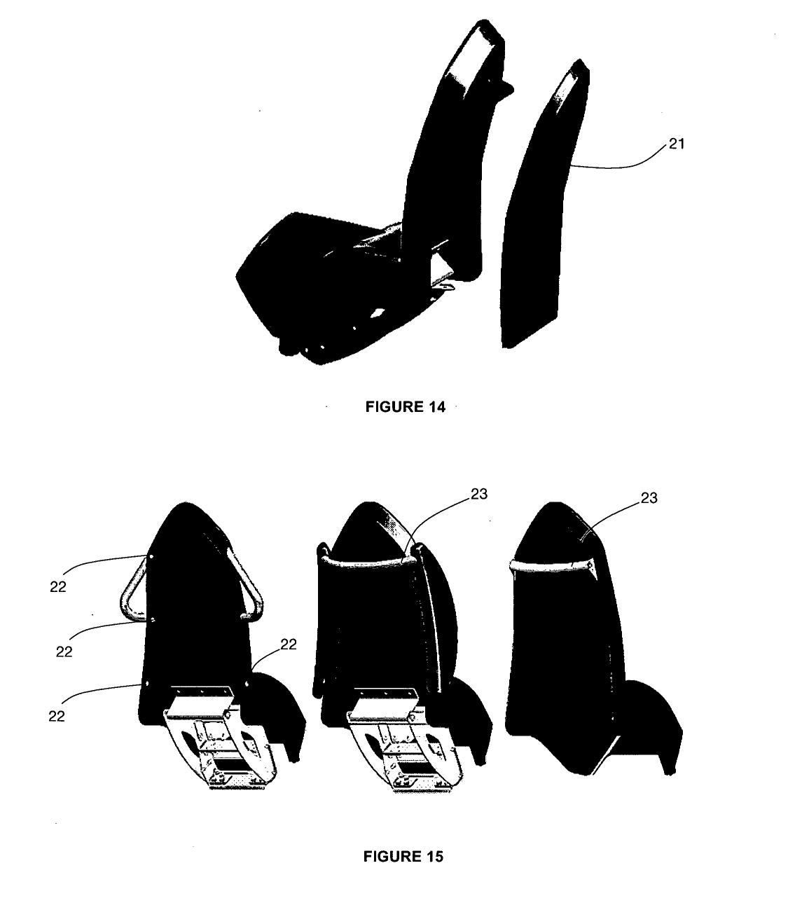

FIG. 11 shows a single shell of fibreglass with pommel 15 extending forward for a user to sit astride and a tapered back 16 upholstered in waterproof fabric moulded to the shape of the seat 17;
FIG. 12 shows a series of seats 17 with modules that are easily interchanged depending on user preference. According to the sea conditions and the intended speed of travel. For example, a pommel module 15 is interchanged with a larger size seat 18 to sit fully on for more relaxed use or a leaning post 19 for medium speeds.
FIG. 13 shows a pommel seat with an optional side bolster 20 similarly manufactured out of strong (metal or composite materials) covered in soft waterproof upholstery, moulded and not stitched for durability;
FIG. 14 shows a removable back pad insert 21 manufactured out of decorative carbon fibre. This removable insert 21 removes any hard impact points for a passenger behind the seat, but also allows for hidden attachment points for the attachment of bolsters, arm rests and the like.
FIG. 15 shows a rear view of a series of seat modules with fasteners 22 securing the back insert which are easily accessible and also function as an attachment point to attach a range of accessories. For example, handle types include a rear mounted arc handle 23 for the least intrusion into aisles between the seats or side mounted hand grips for maximum stability.

### Example 5

### Reverse Orientation of Seat Member

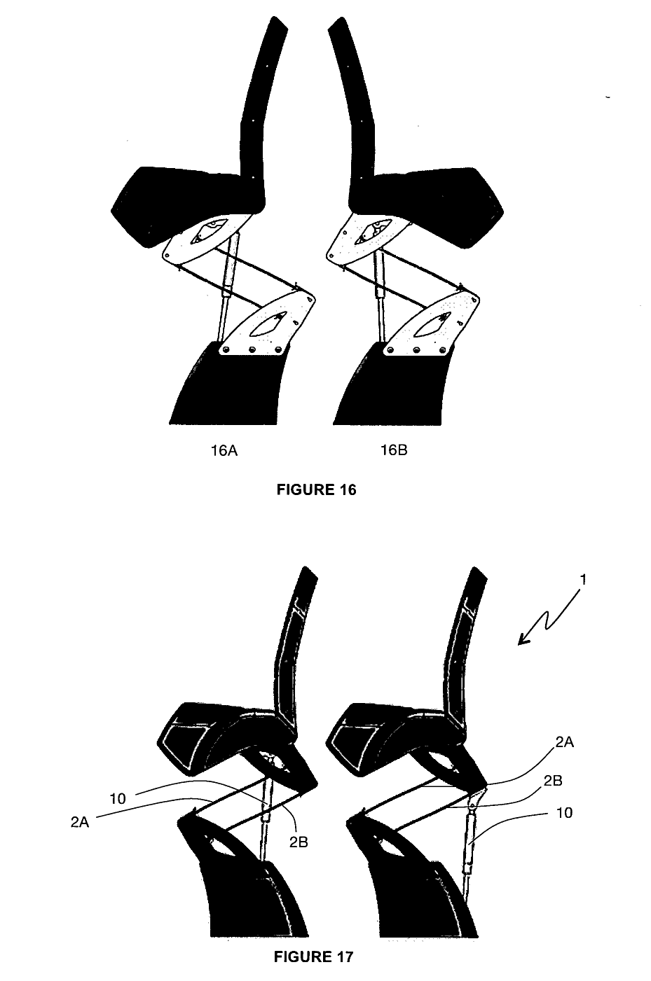

FIG. 16A shows a seat member orientated in a forward direction with respect to the base assembly. This configuration allows for maximum vertical travel of the seat member, but increases the overall footprint of the apparatus. FIG. 16B shows a seat member mounted in a reverse orientation relative to the front of the base assembly to decrease the overall footprint of the apparatus. In this way, a reverse orientation can allow better utilisation of space in some watercraft, altered dynamics and a different aesthetic appeal depending on user preferences. Although in a reverse orientation there is a decrease clearance between the seta member and the lower clamp member.

### Example 6

### Damper Mount Position

FIG. 17 shows a shock mitigation apparatus 1 where the aperture (not shown) of the leaf spring 2A,B is dimensioned and shaped to allow fitment of a damper 10 to pass through the leaf spring 2A,B. This configuration means that the damper 10 is substantially under the centre of mass of the occupant to absorb forces while minimising moments. However, depending on flexure characteristics required, the damper 10 may be mounted in front, behind (as shown) or to either side of the spring 2A,B.

### Example 7

### Base Assemblies

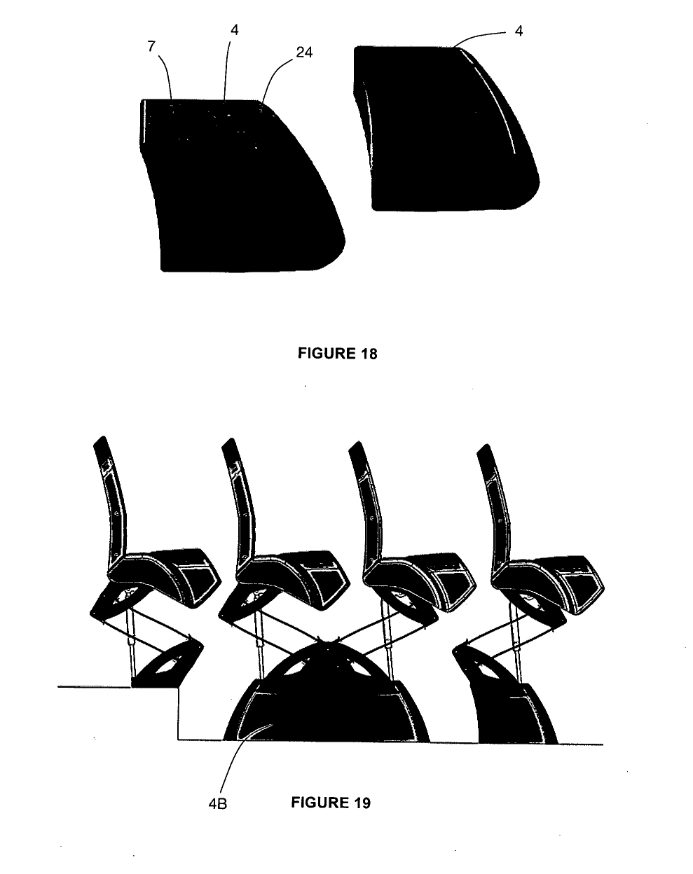

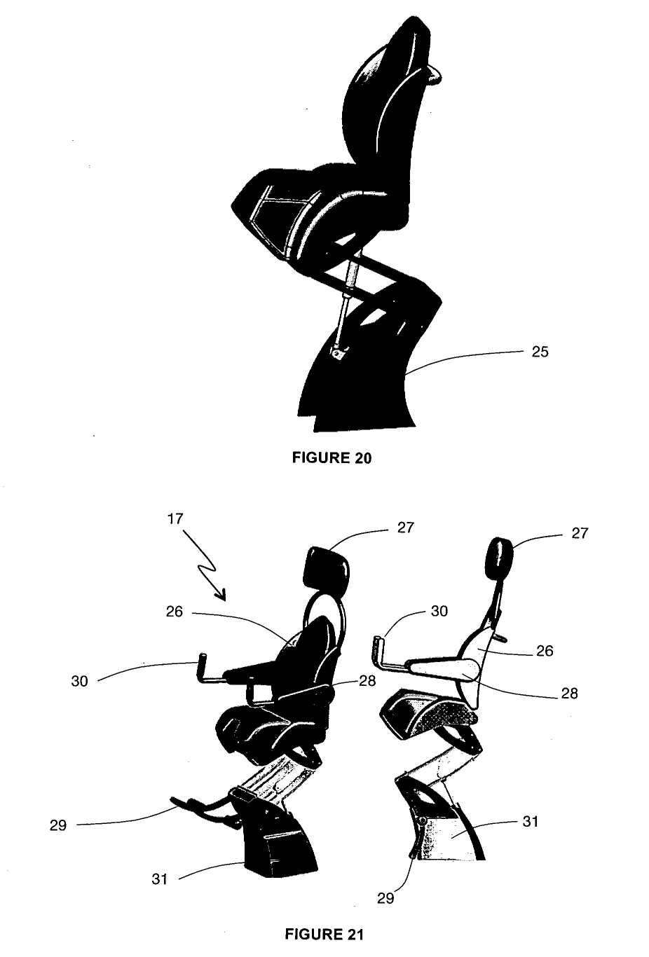

FIG. 18 illustrates a top and bottom view of a base assembly in the form of a plinth 4. The plinth 4 is a fibreglass shell (or manufactured out of pre-impregnated composite fibre for less weight) including an access port 7 for 15 litres of dry stored contained within. The plinth 4 includes a recess 24 for adjustable positioning and/or fitment of a damper (not shown) and a flange (not shown) for mounting to a deck or sole of a boat or alternatively the floor inside provides hidden fastenings for aesthetic appeal and/or to prevent tripping over exposed fittings. A single plinth 4 has a small footprint of approximately 250 mm×350 mm to occupy less space within a boat. Also, a larger footprint plinth 4B is manufactured so that multiple shock mitigation apparatus can be mounted on a single plinth 4B as shown in FIG. 19. An alternative base assembly is shown in FIG. 20 in the form of extended side member supports 25 modified (with or without flanges) for direct mounting to a surface.

### Example 8

### Seat Member Accessories

FIG. 21 illustrates perspective view and a side view of a seat member 17 installed with optional accessories including adjustable side 26 and head 27 restraints, adjustable arm rests 28, adjustable footrests 29, adjustable hand-controls 30, storage 31 and seat belts (not shown).

Aspects of the shock mitigation apparatus and uses thereof have been described by way of example only and it should be appreciated that modifications and additions may be made thereto without departing from the scope of the claims herein.

1. A shock mitigation apparatus including:
at least one seat member;
at least one base assembly for supporting the at least one seat member;
a lower clamp member configured to securely mount to side support members attached to the at least one base assembly;
an upper clamp member configured to securely mount to side support members attached to the at least one seat member;
at least one leaf spring clamped therebetween the lower and upper clamp members,
wherein the at least one leaf spring includes at least one aperture therein configured to tune and control flexure within the at least one leaf spring for shock mitigation in three planes of movement and axis of rotation.

2. The shock mitigation apparatus as claimed in claim 1, wherein the apparatus includes one leaf spring with a stabiliser arm pivotally connected to the lower and upper clamp members.

3. The shock mitigation apparatus as claimed in claim 1, wherein the lower or upper clamp members include a height adjustment mechanism configured to tilt one cantilever end of the at least one leaf spring to provide adjustment of the at least one seat member in a vertical plane of movement without affecting vertical travel of the at least one leaf spring or a damper inserted therebetween.

4. The shock mitigation apparatus as claimed in claim 3, wherein the lower or upper clamp members are divided into two separate parts comprising a first and second arm, wherein the first and second arms pivot and slide relative to one another to form a parallelogram arrangement such that an angle of the end of the at least one leaf springs has its inclination angle relative to the at least one seat member adjusted thereby allowing height adjustment of the at least one seat member.

5. The shock mitigation apparatus as claimed in claim 1, wherein the lower and upper clamp members are symmetrical to provide uniform clamping pressure.

6. The shock mitigation apparatus as claimed in claim 1, wherein the lower clamp member is in a substantially central alignment with respect to the at least one seat member such that a force during shock mitigation acts directly under a centre of mass of the at least one seat member to provide stability and minimise moment about the apparatus.

7. The shock mitigation apparatus as claimed in claim 1, wherein the at least one leaf spring includes an aperture that is substantially centrally located therein.

8. The shock mitigation apparatus as claimed in claim 1, wherein the at least one leaf spring includes two or more apertures therein separated by a bridge.

9. The shock mitigation apparatus as claimed in claim 7, wherein the aperture of the at least one leaf spring is dimensioned and shaped to tune and control stiffness of the at least one leaf spring independently of the three planes of movement and axis of rotation.

10. The shock mitigation apparatus as claimed in claim 7, wherein the aperture of the at least one leaf spring is dimensioned and shaped to provide a progressive stiffening rate of the flexure within the at least one leaf spring.

11. The shock mitigation apparatus as claimed in claim 10, wherein the flexure of the at least one leaf spring is tuned to provide more flex approximately at a middle region of the at least one leaf spring for an initial soft spring rate response followed by a progressively firmer spring rate response upon further compression of the at least one leaf spring, thereby avoiding bottoming out of the at least one leaf spring against a stop.

12. The shock mitigation apparatus as claimed in claim 7, wherein the aperture of the at least one leaf spring is dimensioned and shaped to minimise bending stress of the at least one leaf spring at a region where the at least one leaf spring is clamped to the upper and lower clamping members.

13. The shock mitigation apparatus as claimed in claim 7, wherein the aperture of the at least one leaf spring is dimensioned and shaped to allow fitment of a damper to pass through the at least one leaf spring, such that the damper is substantially under the centre of mass of the at least one seat member and absorb forces while minimising moments about the apparatus.

14. The shock mitigation apparatus as claimed in claim 13, wherein the damper absorbs energy and minimises oscillation of the at least one leaf spring.

15. The shock mitigation apparatus as claimed in claim 13, wherein the damper is located behind the at least one leaf spring and fixed to the upper and lower clamp members.

16. The shock mitigation apparatus as claimed in claim 13, wherein the damper includes a coil spring.

17. The shock mitigation apparatus as claimed in claim 1, wherein the at least one leaf spring is manufactured out of materials selected from: titanium, stainless steel or a composite material.

18. The shock mitigation apparatus as claimed in claim 17, wherein a factor of safety for the stress in the material is greater than or equal to 1.

19. The shock mitigation apparatus as claimed in claim 17, wherein the at least one leaf spring is manufactured out of titanium alloy of grade Beta C which has a modulus of approximately 80-120 MPa.

20. The shock mitigation apparatus as claimed in claim 19, wherein a material thickness of the titanium leaf spring is 3 mm.

21. The shock mitigation apparatus as claimed in claim 1, wherein a width of the at least one leaf spring is approximately 100 to 400 mm.

22. The shock mitigation apparatus as claimed in claim 21, wherein the width of the at least one leaf spring is 200 mm.

23. The shock mitigation apparatus as claimed in claim 1, wherein a length of the at least one leaf spring is approximately 100 to 500 mm.

24. The shock mitigation apparatus as claimed in claim 23, wherein the length of the at least one leaf spring is 400 mm.

25. The shock mitigation apparatus as claimed in claim 1, wherein a stroke of the at least one leaf spring is approximately 50 to 200 mm.

26. The shock mitigation apparatus as claimed in claim 25, wherein the stroke of the at least one leaf spring is configured to allow vertical travel of at least 150 mm to avoid bottoming out of the at least one leaf spring against a stop.

27. The shock mitigation apparatus as claimed in claim 1, wherein lateral stiffness or compliance of the at least one leaf spring is tuned to approximately range from 0.7 to 1.2 mm/kg laterally and independently of vertical compliance of the at least one leaf spring.

28. The shock mitigation apparatus as claimed in claim 7, wherein fore and aft flexure or compliance of the at least one leaf spring is tuned where the aperture is shaped to have an oval direction approximately at right angles to the axis of motion, such that the at least one leaf spring with the oval aperture therein has increased compliance relative to a leaf spring without a round aperture and where both have the same compliance in the vertical (heave) direction.

29. The shock mitigation apparatus as claimed in claim 1, wherein the apparatus includes a pair of leaf springs in a substantially parallel arrangement with respect to each other for torsional rigidity.

30. The shock mitigation apparatus as claimed in claim 1, wherein the at least one seat member is a modular unit comprising interchangeable units of a pommel design seat, a leaning post attachment, or a regular chair design seat.

31. The shock mitigation apparatus as claimed in claim 30, wherein the pommel design seat extends forward from a back rest to allow an occupant to sit astride and give maximum lateral stability and a firm footing in use.

32. The shock mitigation apparatus as claimed in claim 1, wherein the at least one seat member is mounted in a reverse orientation relative to the at least one base assembly to decrease the overall footprint of the apparatus.

33. The shock mitigation apparatus as claimed in claim 1, wherein the at least one seat member includes a swiveling mechanism to enable the at least one seat member to rotate up to 360 degrees with respect to the at least one base assembly.

34. The shock mitigation apparatus as claimed in claim 1, wherein the at least one base assembly are flanges integrated or attached to the side support members to allow direct attachment to a deck or ground surface.

35. The shock mitigation apparatus as claimed in claim 1, wherein the at least one base assembly is a plinth.

36. The shock mitigation apparatus as claimed in claim 35, wherein the plinth includes an access port to access a storage compartment contained therein.

37. The shock mitigation apparatus as claimed in claim 35, wherein the plinth includes a floor to provide hidden fastenings and a recess for adjustable positioning or fitment of a damper.

38. The shock mitigation apparatus as claimed in claim 1, wherein a plurality of shock mitigation apparatus are mounted to the at least one base assembly substantially in a row or adjacent to each other.

39. The shock mitigation apparatus as claimed in claim 1, wherein the shock mitigation apparatus is in a watercraft.

40. (canceled)
